(19) United States
(12) Patent Application Publication
(10) Pub. No.: US 2022/0416600 A1
(43) Pub. Date: Dec. 29, 2022

(54) ROTOR CORE AND ROTATING ELECTRICAL MACHINE

(71) Applicant: NIDEC CORPORATION, Kyoto (JP)

(72) Inventor: Ayami FURUGORI, Kyoto (JP)

(21) Appl. No.: 17/851,040

(22) Filed: Jun. 28, 2022

(30) Foreign Application Priority Data
Jun. 29, 2021 (JP) 2021-107254

(51) Int. Cl. H02K 1/276

(52) U.S. Cl. CPC H02K 1/2766

(57) ABSTRACT

A rotor core rotatable about an axis has: a pair of first magnet holes; a pair of second magnet holes radially outside the first magnet holes; and first and second through holes axially penetrating the rotor core and positioned radially inside the first magnet holes. When viewed along the axis, an opening edge of each of the first and second through holes includes a first straight portion extending radially, a second straight portion extending toward a circumferential side from a radially inner end of the first straight portion, a third straight portion extending radially outward from an end of the second straight portion, a first curved portion extending toward a circumferential side from a radially outer end of the first straight portion, and a second curved portion connecting an end on a circumferential side of the first curved portion and a radially outer end of the third straight portion.

### CROSS-REFERENCE TO RELATED APPLICATIONS

The present invention claims priority under 35 U.S.C. § 119 to Japanese Patent Application No. 2021-107254 filed on Jun. 29, 2021, the entire content of which is incorporated herein by reference.

### FIELD OF THE INVENTION

The present invention relates to a rotor core and a rotating electrical machine.

### BACKGROUND

A rotor core having a through hole is known. For example, a rotor core having a communication hole with a circular cross section, a rotor core having a communication hole with a triangular cross section, and the like are described.

The through holes as described above are provided for the purpose of reducing the weight of the rotor cores, for example. The larger the through hole is, the more the rotor core can be reduced in weight. However, there is a problem that the strength of the rotor core decreases as the through hole becomes larger. Therefore, it is difficult to make the through hole larger than a certain degree, and it has not been able to sufficiently reduce the weight of the rotor core in some cases.

Summary

An aspect of an exemplary rotor core of the present invention is a rotor core of a rotor rotatable about a central axis, the rotor core including: a pair of first magnet holes circumferentially adjacent to each other; a pair of second magnet holes positioned radially outside the pair of first magnet holes and circumferentially adjacent to each other; and a first through hole and a second through hole axially penetrating the rotor core and circumferentially adjacent to each other. The first through hole and the second through hole are positioned radially inside the pair of first magnet holes. When viewed in an axial direction, each of an opening edge of the first through hole and an opening edge of the second through hole includes a first straight portion extending along a radial direction, a second straight portion extending toward a circumferential one side from a radially inner end of the first straight portion, a third straight portion extending radially outward from an end on a circumferential one side of the second straight portion, a first curved portion extending toward a circumferential one side from a radially outer end of the first straight portion, and a second curved portion connecting an end on a circumferential one side of the first curved portion and a radially outer end of the third straight portion.

An aspect of an exemplary rotating electrical machine of the present invention includes: a rotor having the rotor core and a plurality of magnets arranged in the pair of first magnet holes and the pair of second magnet holes; and a stator opposing the rotor across a gap.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a cross-sectional view illustrating a rotating electrical machine of an preferred embodiment;

FIG. 2 is a cross-sectional view illustrating a rotor of an preferred embodiment, and is a II-II cross-sectional view in FIG. 1;

FIG. 3 is a cross-sectional view illustrating a part of the rotor of the preferred embodiment, and is a partially enlarged view of FIG. 2; and

FIG. 4 is a cross-sectional view illustrating a part of a rotor core of an preferred embodiment.

### DETAILED DESCRIPTION

Each figure appropriately illustrates a central axis J. The central axis J is an imaginary line passing through the center of the rotating electrical machine in the following preferred embodiment. A Z axis appropriately illustrated in each figure indicates a direction where the central axis J extends. In the following description, an axial direction of the central axis J, that is, a direction parallel to the Z axis is simply referred to as “axial direction/axial/axially”, a radial direction about the central axis J is simply referred to as “radial direction/radial/radially”, and a circumferential direction about the central axis J is simply referred to as “circumferential direction/circumferential/circumferentially”. A side of the axial direction on which the arrow of the Z axis is directed (+Z side) is referred to as “upper side”, and a side of the axial direction opposite of the side on which the arrow of the Z axis is directed (−Z side) is referred to as “lower side”.

An arrow 0 appropriately illustrated in each figure indicates the circumferential direction. The arrow θ is directed in a clockwise orientation about the central axis J when viewed from the upper side. In the following description, a side of the circumferential direction to which the arrow θ is directed with a certain object as a reference (+θ side), that is, a side proceeding clockwise as viewed from the upper side is referred to as “circumferential front side”, and a side of the circumferential direction opposite of the side to which the arrow θ is directed with a certain object as a reference (−θ side), that is, a side proceeding counterclockwise as viewed from the upper side is referred to as “circumferential rear side”.

Note that upper side, lower side, circumferential front side, and circumferential rear side are names for simply describing an arrangement relationship or the like of each part, and the actual arrangement relationship or the like may be an arrangement relationship or the like other than the arrangement relationship or the like indicated by these names.

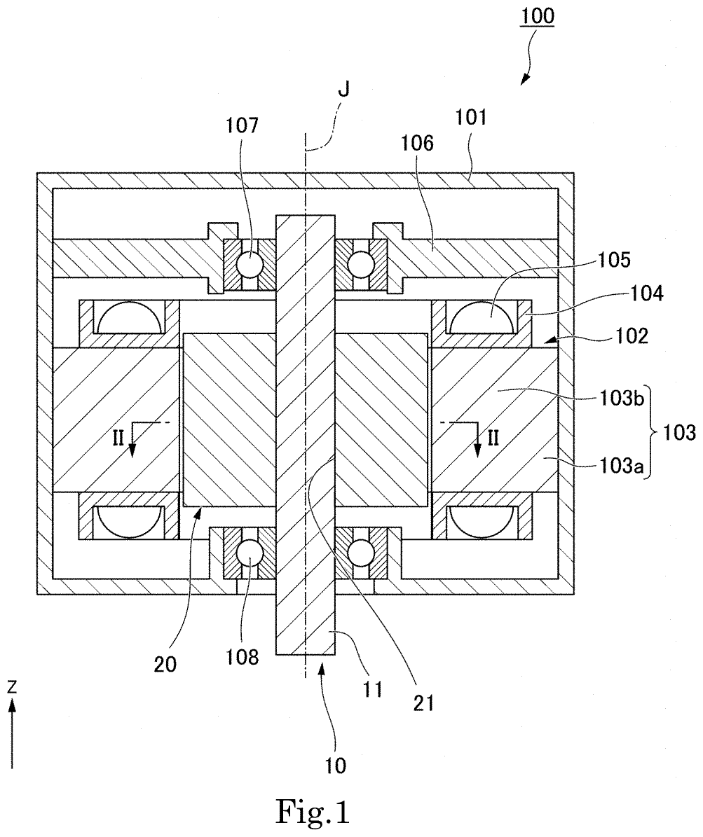

As illustrated in FIG. 1, a rotating electrical machine 100 of the present preferred embodiment is an inner rotor type rotating electrical machine. In the present preferred embodiment, the rotating electrical machine 100 is a motor. The rotating electrical machine 100 includes a housing 101, a rotor 10, a stator 102, a bearing holder 106, and bearings 107 and 108. The housing 101 accommodates therein the rotor 10, the stator 102, the bearing holder 106, and the bearings 107 and 108. The bottom part of the housing 101 holds the bearing 108. The bearing holder 106 holds the bearing 107. The bearings 107 and 108 are, for example, ball bearings.

The stator 102 opposes the rotor 10 across a gap. The stator 102 is positioned radially outside the rotor 10. The stator 102 has a stator core 103, an insulator 104, and a plurality of coils 105. The stator core 103 has an annular core back 103a and a plurality of teeth 103b protruding radially inward from the core back 103a. The plurality of coils 105 are attached to each of the plurality of teeth 103b via the insulator 104.

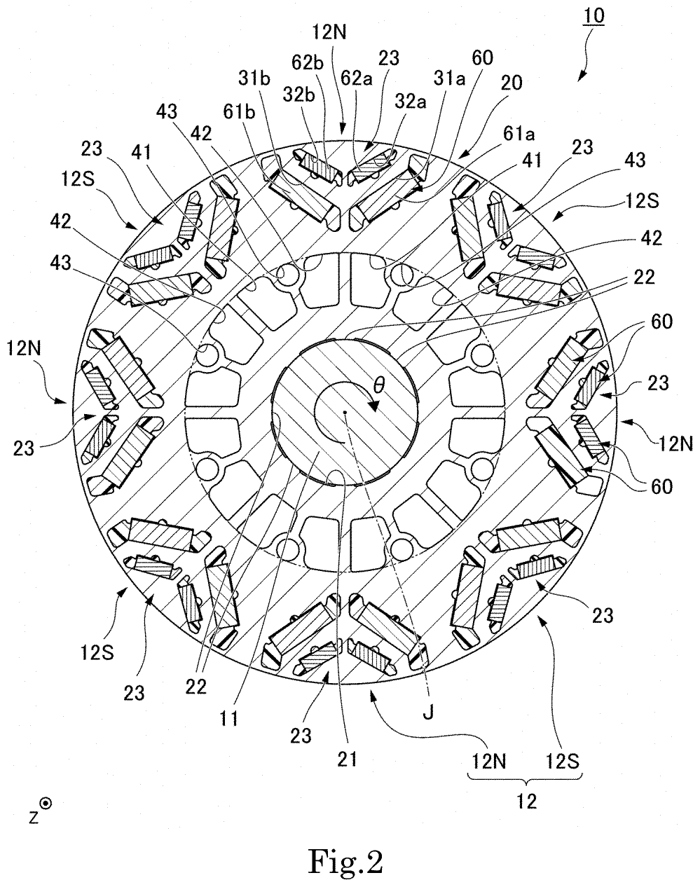

The rotor 10 can rotate about the central axis J extending in the axial direction. As illustrated in FIG. 2, the rotor 10 includes a shaft 11, a rotor core 20, and a plurality of magnets 60. The shaft 11 has a columnar shape that extends in the axial direction about the central axis J. As illustrated in FIG. 1, the shaft 11 is rotatably supported about the central axis J by the bearings 107 and 108.

The rotor core 20 is a magnetic body. The rotor core 20 is fixed to an outer peripheral surface of the shaft 11. Although not illustrated, the rotor core 20 is configured with a plurality of plate members, such as electromagnetic steel plates, stacked in the axial direction. The rotor core 20 has a shaft hole 21 axially penetrating the rotor core 20. As illustrated in FIG. 2, the shaft hole 21 has a circular or substantially circular shape about the central axis J as viewed in the axial direction. A protrusion 22 protruding radially inward is provided on an inner peripheral surface of the shaft hole 21. A plurality of the protrusions 22 are provided at intervals along the circumferential direction. The plurality of protrusions 22 are arranged at equal intervals over the entire circumference along the circumferential direction. In the present preferred embodiment, eight protrusions 22 are provided. The shaft 11 passes through the shaft hole 21 in the axial direction. In the present preferred embodiment, the shaft 11 is press-fitted into the shaft hole 21. The outer peripheral surface of the shaft 11 is in contact with the radially inner surfaces of the plurality of protrusions 22. When the shaft 11 is press-fitted into the shaft hole 21, the plurality of protrusions 22 are compressed and deformed radially outward.

The rotor core 20 has a magnet holding portion 23 that holds the magnet 60 on the radial outside the shaft hole 21. The magnet holding portion 23 is provided in a radially outer part of the rotor core 20. A plurality of the magnet holding portions 23 are provided along the circumferential direction. The plurality of magnet holding portions 23 are arranged at equal intervals over the entire circumference along the circumferential direction. In the present preferred embodiment, eight magnet holding portions 23 are provided.

The magnet holding portion 23 has a pair of first magnet holes 31a and 31b circumferentially adjacent to each other and a pair of second magnet holes 32a and 32b circumferentially adjacent to each other. That is, the rotor core 20 has the pair of first magnet holes 31a and 31b and the pair of second magnet holes 32a and 32b. The pair of first magnet holes 31a and 31b and the pair of second magnet holes 32a and 32b are positioned radially outside the shaft hole 21. In the present preferred embodiment, the pair of first magnet holes 31a and 31b and the pair of second magnet holes 32a and 32b axially penetrate the rotor core 20.

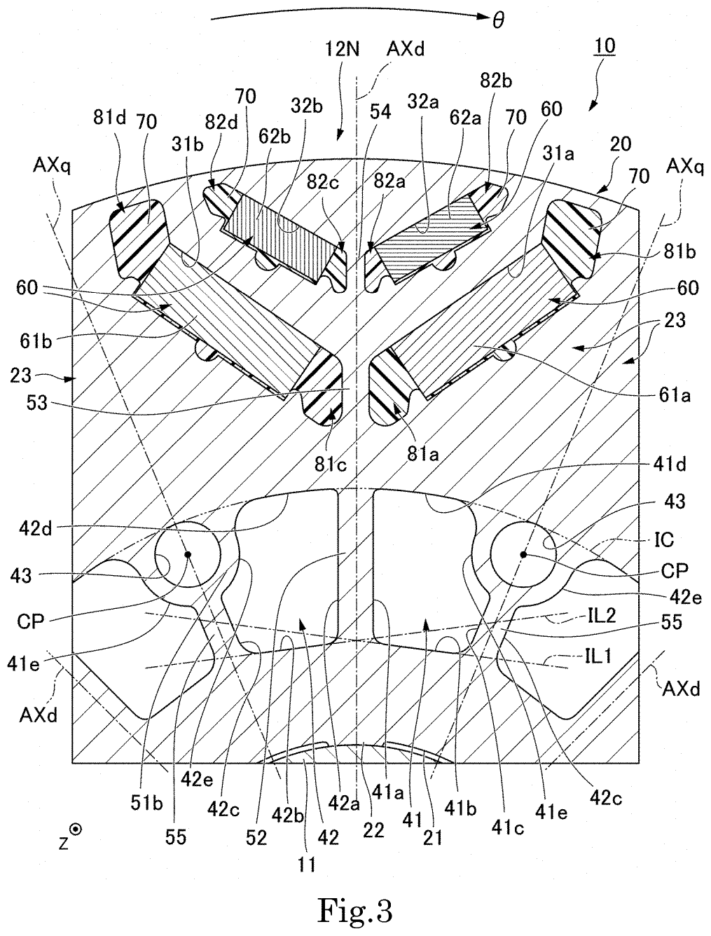

As illustrated in FIG. 3, the pair of first magnet holes 31a and 31b are arranged at intervals in the circumferential direction. The first magnet hole 31a is positioned on the circumferential front side (+θ side) of the first magnet hole 31b. The pair of first magnet holes 31a and 31b extend substantially linearly in a direction inclined obliquely with respect to the radial direction when viewed in the axial direction. The pair of first magnet holes 31a and 31b extend in directions away from each other in the circumferential direction toward the radial outside from the radial inside when viewed in the axial direction. That is, the circumferential distance between the first magnet hole 31a and the first magnet hole 31b increases toward the radial outside from the radial inside.

The first magnet hole 31a is positioned on the circumferential front side (+θ side) toward the radial outside from the radial inside. The first magnet hole 31b is positioned on the circumferential rear side (−θ side) toward the radial outside from the radial inside. The pair of first magnet holes 31a and 31b are arranged along a V shape expanding in the circumferential direction toward the radial outside when viewed in the axial direction. The radially outer ends of the pair of first magnet holes 31a and 31b are positioned at a radially outer edge of the rotor core 20.

The first magnet hole 31a and the first magnet hole 31b are arranged circumferentially across a magnetic pole center line AXd when viewed in the axial direction. The magnetic pole center line AXd is a radially extending imaginary line that passes through the circumferential center of a magnetic pole portion 12 described later and the central axis J. The magnetic pole center line AXd is provided for each magnetic pole portion 12. The magnetic pole center line AXd passes through on a d axis of the rotor 10 when viewed in the axial direction. The direction where the magnetic pole center line AXd extends is the d-axis direction of the rotor 10. The first magnet hole 31a and the first magnet hole 31b are arranged line-symmetrically with respect to the magnetic pole center line AXd when viewed in the axial direction.

In the following description, in each magnet holding portion 23 and each magnetic pole portion 12 described later, a side of the circumferential direction approaching the magnetic pole center line AXd with a certain object as a reference is referred to as “circumferential inside”, and a side of the circumferential direction away from the magnetic pole center line AXd with a certain object as a reference is referred to as “circumferential outside”.

The pair of second magnet holes 32a and 32b are arranged at intervals in the circumferential direction. The second magnet hole 32a is positioned on the circumferential front side (+θ side) of the second magnet hole 32b. The pair of second magnet holes 32a and 32b are positioned radially outside the pair of first magnet holes 31a and 31b. The second magnet hole 32a is positioned radially outside the first magnet hole 31a. The second magnet hole 32b is positioned radially outside the first magnet hole 31b. The pair of second magnet holes 32a and 32b are positioned between the pair of first magnet holes 31a and 31b in the circumferential direction.

The pair of second magnet holes 32a and 32b extend substantially linearly in a direction inclined obliquely with respect to the radial direction when viewed in the axial direction. The pair of second magnet holes 32a and 32b extend in directions away from each other in the circumferential direction toward the radial outside from the radial inside when viewed in the axial direction. That is, the circumferential distance between the second magnet hole 32a and the second magnet hole 32b increases toward the radial outside from the radial inside.

The second magnet hole 32a is positioned on the circumferential front side (+θ side) toward the radial outside from the radial inside. The second magnet hole 32b is positioned on the circumferential rear side (−θ side) toward the radial outside from the radial inside. The pair of second magnet holes 32a and 32b are arranged along a V shape expanding in the circumferential direction toward the radial outside when viewed in the axial direction. The radially outer ends of the pair of second magnet holes 32a and 32b are positioned at a radially outer edge of the rotor core 20. The second magnet hole 32a and the second magnet hole 32b are arranged circumferentially across the magnetic pole center line AXd when viewed in the axial direction. The second magnet hole 32a and the second magnet hole 32b are arranged line-symmetrically with respect to the magnetic pole center line AXd when viewed in the axial direction.

The plurality of magnets 60 are arranged in the pair of first magnet holes 31a and 31b and the pair of second magnet holes 32a and 32b. A method of fixing the magnet 60 in each magnet hole is not particularly limited. In the present preferred embodiment, the magnet 60 is fixed in each magnet hole by filling, with a resin 70, a part of each magnet hole other than the part where the magnet 60 is positioned.

The type of the plurality of magnets 60 is not particularly limited. The magnet 60 may be, for example, a neodymium magnet or a ferrite magnet. The plurality of magnets 60 include a plurality of pairs of first magnets 61a and 61b and a plurality of pairs of second magnets 62a and 62b. In the present preferred embodiment, eight pairs of first magnets 61a and 61b and eight pairs of second magnets 62a and 62b are provided.

The pair of first magnets 61a and 61b are arranged in the pair of first magnet holes 31a and 31b, respectively. The first magnet 61a is fitted in a center part of the first magnet hole 31a in the direction where the first magnet hole 31a extends when viewed in the axial direction. The first magnet 61b is fitted in a center part of the first magnet hole 31b in the direction where the first magnet hole 31b extends when viewed in the axial direction. The pair of second magnets 62a and 62b are arranged in the pair of second magnet holes 32a and 32b, respectively. The second magnet 62a is fitted in a center part of the second magnet hole 32a in the direction where the second magnet hole 32a extends when viewed in the axial direction. The second magnet 62b is fitted in a center part of the second magnet hole 32b in the direction where the second magnet hole 32b extends when viewed in the axial direction.

As illustrated in FIG. 2, the rotor 10 is provided with a plurality of the magnetic pole portions 12 along the circumferential direction. Each magnetic pole portion 12 includes one pair of first magnet holes 31a and 31b, one pair of first magnets 61a and 61b, one pair of second magnet holes 32a and 32b, and one pair of second magnets 62a and 62b. In the present preferred embodiment, eight magnetic pole portions 12 are provided. The plurality of magnetic pole portions 12 are arranged at equal intervals over the entire circumference along the circumferential direction. The plurality of magnetic pole portions 12 include a plurality of magnetic pole portions 12N in which the magnetic pole on the outer peripheral surface of the rotor core 20 is an N pole and a plurality of magnetic pole portions 12S in which the magnetic pole on the outer peripheral surface of the rotor core 20 is an S pole. In the present preferred embodiment, four magnetic pole portions 12N and four magnetic pole portions 12S are provided. The four magnetic pole portions 12N and the four magnetic pole portions 12S are alternately arranged along the circumferential direction. The configurations of the magnetic pole portions 12 are similar to one another except that the magnetic poles on the outer peripheral surface of the rotor core 20 are different and the circumferential positions are different.

As illustrated in FIG. 3, the pair of first magnets 61a and 61b and the pair of second magnets 62a and 62b have a rectangular or substantially rectangular shape, for example, when viewed in the axial direction. Although not illustrated, the pair of first magnets 61a and 61b and the pair of second magnets 62a and 62b have, for example, a cuboid shape. Although not illustrated, the pair of first magnets 61a and 61b and the pair of second magnets 62a and 62b are provided over the entire axial direction in each magnet hole, for example. The pair of first magnets 61a and 61b are arranged along a V shape expanding in the circumferential direction toward the radial outside when viewed in the axial direction. The pair of second magnets 62a and 62b are arranged along a V shape expanding in the circumferential direction toward the radial outside when viewed in the axial direction on the radial outside of the pair of first magnets 61a and 61b.

Both sides of the first magnet 61a in the direction where the first magnet 61a extends when viewed in the axial direction are provided with first flux barrier portions 81a and 81b. The first flux barrier portion 81a is configured by filling a radially inner end of the first magnet hole 31a with the resin 70. The first flux barrier portion 81b is configured by filling a radially outer end of the first magnet hole 31a with the resin 70. Both sides of the first magnet 61b in the direction where the first magnet 61b extends when viewed in the axial direction are provided with first flux barrier portions 81c and 81d. The first flux barrier portion 81c is configured by filling a radially inner end of the first magnet hole 31b with the resin 70. The first flux barrier portion 81d is configured by filling a radially outer end of the first magnet hole 31b with the resin 70.

Both sides of the second magnet 62a in the direction where the second magnet 62a extends when viewed in the axial direction are provided with second flux barrier portions 82a and 82b. The second flux barrier portion 82a is configured by filling a radially inner end of the second magnet hole 32a with the resin 70. The second flux barrier portion 82b is configured by filling a radially outer end of the second magnet hole 32a with the resin 70. Both sides of the second magnet 62b in the direction where the second magnet 62b extends when viewed in the axial direction are provided with second flux barrier portions 82c and 82d. The second flux barrier portion 82c is configured by filling a radially inner end of the second magnet hole 32b with the resin 70. The second flux barrier portion 82d is configured by filling a radially outer end of the second magnet hole 32b with the resin 70.

In the present description, when the magnet has a rectangular or substantially rectangular shape when viewed in the axial direction as in the first magnets 61a and 61b of the present preferred embodiment, for example, the “direction where the magnet extends when viewed in the axial direction” is a direction where the long side of the rectangular magnet extends. That is, for example, in the present embodiment, the “direction where the first magnet 61a extends when viewed in the axial direction” is a direction where the long side of the rectangular first magnet 61a extends when viewed in the axial direction.

In the present description, the “flux barrier portion” is a portion that can suppress the flow of magnetic flux. That is, the magnetic flux hardly passes through each flux barrier portion. Each flux barrier portion is not particularly limited as long as it can suppress the flow of magnetic flux, and it may include a void and may include a non-magnetic portion other than the resin.

The magnetic pole of the first magnet 61a is arranged along a direction orthogonal to the direction where the first magnet 61a extends when viewed in the axial direction. The magnetic pole of the first magnet 61b is arranged along a direction orthogonal to the direction where the first magnet 61b extends when viewed in the axial direction. In the pair of first magnets 61a and 61b, the magnetic pole of the first magnet 61a of the magnetic poles positioned on the radial outside and the magnetic pole of the magnetic poles of the first magnet 61b positioned on the radial outside are the same. In the pair of first magnets 61a and 61b, the magnetic pole, of the magnetic poles of the first magnet 61a, positioned radially inner side and the magnetic pole, of the magnetic poles of the first magnet 61b, positioned radially inner side are the same.

The magnetic pole of the second magnet 62a is arranged along a direction orthogonal to the direction where the second magnet 62a extends when viewed in the axial direction. The magnetic pole of the second magnet 62b is arranged along a direction orthogonal to the direction where the second magnet 62b extends when viewed in the axial direction. In the pair of second magnets 62a and 62b, the magnetic pole of the second magnet 62a of the magnetic poles positioned on the radial outside and the magnetic pole of the magnetic poles of the second magnet 62b positioned on the radial outside are the same. In the pair of second magnets 62a and 62b, the magnetic pole, of the magnetic poles of the second magnet 62a, positioned radially inner side and the magnetic pole, of the magnetic poles of the second magnet 62b, positioned radially inner side are the same.

In the magnetic pole portion 12N, the magnetic pole positioned on the radial outside of the magnetic poles of the magnets 60 is, for example, the N pole. In the magnetic pole portion 12N, the magnetic pole, of the magnetic poles of the magnets 60, positioned radially inner side is, for example, the S pole. In the magnetic pole portion 12S, the magnetic pole of each magnet 60 is arranged to be inverted with respect to the magnetic pole portion 12N. That is, in the magnetic pole portion 12S, the magnetic pole positioned on the radial outside of the magnetic poles of the magnets 60 is, for example, the S pole. In the magnetic pole portion 12S, the magnetic pole, of the magnetic poles of the magnets 60, positioned radially inner side is, for example, the N pole.

The rotor core 20 has a first through hole 41 and a second through hole 42 adjacent to each other in the circumferential direction. The first through hole 41 is arranged at an interval on the circumferential front side (+θ side) of the second through hole 42. The first through hole 41 and the second through hole 42 axially penetrate the rotor core 20. As illustrated in FIG. 2, in the present preferred embodiment, the first through hole 41 and the second through hole 42 are each provided on the radial inside of the plurality of magnet holding portions 23. The first through hole 41 and the second through hole 42 are positioned radially inside the pair of first magnet holes 31a and 31b. The first through hole 41 is positioned radially inside the first magnet hole 31a. The second through hole 42 is positioned radially inside the first magnet hole 31b.

As illustrated in FIG. 3, the pair of first through hole 41 and second through hole 42 provided on the radial inside of each magnet holding portion 23 are arranged circumferentially across the magnetic pole center line AXd provided in each magnet holding portion 23. In the present preferred embodiment, the first through hole 41 and the second through hole 42 have shapes symmetrical with each other in the circumferential direction. The first through hole 41 and the second through hole 42 are arranged line-symmetrically with respect to the magnetic pole center line AXd when viewed in the axial direction. In the following description, the description of the second through hole 42 may be omitted for the same configuration as that of the first through hole 41 except that the second through hole is line-symmetric with respect to the magnetic pole center line AXd.

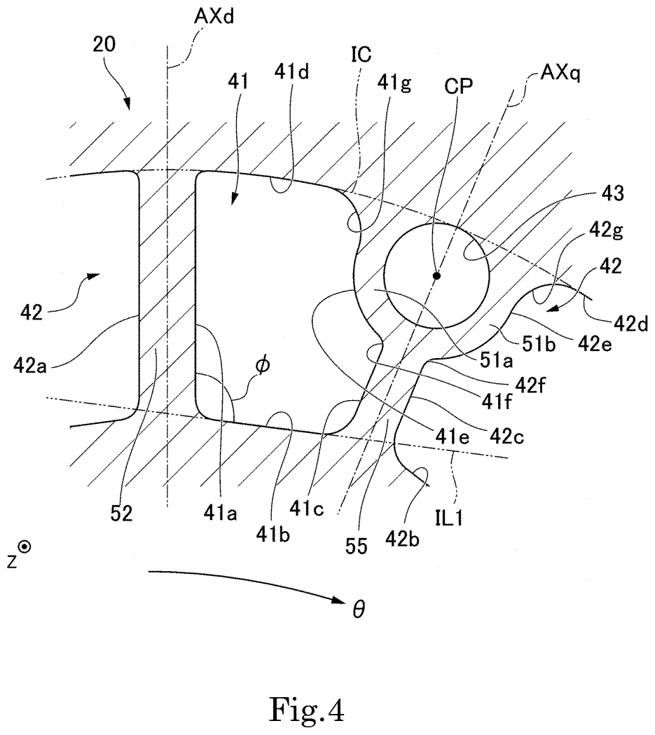

As illustrated in FIG. 4, when viewed in the axial direction, the opening edge of the first through hole 41 has a first straight portion 41a, a second straight portion 41b, a third straight portion 41c, a first curved portion 41d, and a second curved portion 41e. The first straight portion 41a extends along the radial direction. In the present preferred embodiment, the first straight portion 41a linearly extends in parallel with the magnetic pole center line AXd sandwiched between the first through hole 41 and the second through hole 42 in the circumferential direction.

The second straight portion 41b extends toward the circumferential outside (+θ side) from the radially inner end of the first straight portion 41a. In the present preferred embodiment, the second straight portion 41b extends linearly in parallel with an imaginary straight line IL1. The imaginary straight line IL1 is an imaginary line extending linearly in a direction intersecting the magnetic pole center line AXd when viewed in the axial direction. The second straight portion 41b overlaps the imaginary straight line IL1 when viewed in the axial direction. The second straight portion 41b is positioned on the radial outside toward the circumferential outside. The connection portion between the first straight portion 41a and the second straight portion 41b has an arc shape protruding toward the outside of the first through hole 41. In the present preferred embodiment, an angle φ formed by the first straight portion 41a and the second straight portion 41b is an obtuse angle. The angle φ formed by the first straight portion 41a and the second straight portion 41b is equal to the larger one of the angles formed by the intersection of the magnetic pole center line AXd and the imaginary straight line IL1.

The third straight portion 41c extends radially outward from the circumferentially outer (+θ side) end of the second straight portion 41b. In the present preferred embodiment, the third straight portion 41c linearly extends in parallel with an inter-magnetic pole center line AXq positioned on the circumferential outside of the first through hole 41. The inter-magnetic pole center line AXq is a radially extending imaginary line that passes through the circumferential center between the magnetic pole portions 12 adjacent to each other in the circumferential direction and the central axis J. The inter-magnetic pole center line AXq passes through on a q axis of the rotor 10 when viewed in the axial direction. The direction where the inter-magnetic pole center line AXq extends is the q-axis direction of the rotor 10. The inter-magnetic pole center line AXq is provided in every interval between the magnetic pole portions 12. The direction where the magnetic pole center line AXd extends and the direction where the inter-magnetic pole center line AXq extends are directions intersecting each other. The magnetic pole center line AXd and the inter-magnetic pole center line AXq are alternately provided along the circumferential direction. The connection portion between the second straight portion 41b and the third straight portion 41c has an arc shape protruding toward the outside of the first through hole 41.

The first curved portion 41d extends toward the circumferential outside (+θ side) from the radially outer end of the first straight portion 41a. In the present preferred embodiment, the first curved portion 41d extends in an arc shape along an imaginary circle IC. The imaginary circle IC is an imaginary circle about the central axis J. The first curved portion 41d is arranged on the imaginary circle IC as viewed in the axial direction. The circumferentially outer end of the first curved portion 41d is positioned on the circumferential inside (−θ side) relative to the circumferentially outer end of the second straight portion 41b. The circumferentially outer end of the first curved portion 41d is an end of the first curved portion 41d on the side connected to the second curved portion 41e. The circumferentially outer end of the second straight portion 41b is an end of the second straight portion 41b on the side connected to the third straight portion 41c. That is, in the present preferred embodiment, the end of the first curved portion 41d on the side connected to the second curved portion 41e is positioned closer to the other through hole, that is, the second through hole 42 in the circumferential direction than the end of the second straight portion 41b on the side connected to the third straight portion 41c. The connection portion between the first straight portion 41a and the first curved portion 41d has an arc shape protruding toward the outside of the first through hole 41.

The second curved portion 41e connects the circumferentially outer (+θ side) end of the first curved portion 41d and the radially outer end of the third straight portion 41c. In the present preferred embodiment, the second curved portion 41e has a shape curved in an orientation recessed toward the side (−θ side) where the other through hole, that is, the second through hole 42 is positioned in the circumferential direction as viewed in the axial direction. The second curved portion 41e has an arc shape recessed toward the inside of the first through hole 41. The second curved portion 41e has an arc shape arranged coaxially with a center CP of a third through hole 43 described later.

The connection portion between the third straight portion 41c and the second curved portion 41e is a first arc portion 41f having an arc shape as viewed in the axial direction. The first arc portion 41f has an arc shape protruding toward the outside of the first through hole 41. The connection portion between the first curved portion 41d and the second curved portion 41e is a second arc portion 41g having an arc shape as viewed in the axial direction. The second arc portion 41g has an arc shape protruding toward the outside of the first through hole 41. In the present preferred embodiment, the curvature radius of the second arc portion 41g is larger than the curvature radius of the first arc portion 41f. In the present preferred embodiment, the curvature radius of the second curved portion 41e is larger than the curvature radius of the second arc portion 41g.

As illustrated in FIG. 3, when viewed in the axial direction, the opening edge of the second through hole 42 has a first straight portion 42a, a second straight portion 42b, a third straight portion 42c, a first curved portion 42d, and a second curved portion 42e. Each portion of the opening edge of the second through hole 42 is similar to each portion having a similar name in the opening edge of the first through hole 41 except that the portions are arranged line-symmetrically with respect to the magnetic pole center line AXd. That is, in the present preferred embodiment, in each of the first through hole 41 and the second through hole 42, the second straight portions 41b and 42b and the first curved portions 41d and 42d extend to the side away from the other through hole of the first through hole 41 and the second through hole 42, respectively, in the circumferential direction, that is, to the circumferential outside from the first straight portions 41a and 42a. The circumferential outside of the first through hole 41 is the circumferential front side (+θ side), and the circumferential outside of the second through hole 42 is the circumferential rear side (−θ side).

In the present preferred embodiment, the second straight portion 42b extends linearly in parallel with an imaginary straight line IL2. The imaginary straight line IL2 is an imaginary line extending linearly in a direction intersecting the magnetic pole center line AXd when viewed in the axial direction. The second straight portion 42b overlaps the imaginary straight line IL2 when viewed in the axial direction. The imaginary straight line IL1 and the imaginary straight line IL2 intersect each other on the magnetic pole center line AXd.

As illustrated in FIG. 4, the connection portion between the third straight portion 42c and the second curved portion 42e is a first arc portion 42f having an arc shape when viewed in the axial direction. The first arc portion 42f has an arc shape protruding toward the outside of the second through hole 42. The connection portion between the first curved portion 42d and the second curved portion 42e is a second arc portion 42g having an arc shape when viewed in the axial direction. The second arc portion 42g has an arc shape protruding toward the outside of the second through hole 42. In the present preferred embodiment, the curvature radius of the second arc portion 42g is larger than the curvature radius of the first arc portion 42f. In the present preferred embodiment, the curvature radius of the second curved portion 42e is larger than the curvature radius of the second arc portion 42g.

As illustrated in FIG. 3, in the present preferred embodiment, the first through hole 41 and the second through hole 42 are each positioned between the d axis and the q axis of the rotor 10 in the circumferential direction. In other words, the first through hole 41 and the second through hole 42 are each positioned between the magnetic pole center line AXd and the inter-magnetic pole center line AXq in the circumferential direction. The first through hole 41 is positioned between the magnetic pole center line AXd (d axis) and the inter-magnetic pole center line AXq (q axis) arranged adjacent to the circumferential front side (+θ side) of the magnetic pole center line AXd. The second through hole 42 is positioned between the magnetic pole center line AXd (d axis) and the inter-magnetic pole center line AXq (q axis) arranged adjacent to the circumferential rear side (−θ side) of the magnetic pole center line AXd.

In the present preferred embodiment, in each of the first through hole 41 and the second through hole 42, the circumferential outer side corresponds to the “circumferential one side”. The circumferential outside (circumferential one side) of the first through hole 41 is the circumferential front side (+θ side). The circumferential outside (circumferential one side) of the second through hole 42 is the circumferential rear side (−θ side).

The rotor core 20 has the third through hole 43 axially penetrating the rotor core 20. In the present preferred embodiment, the third through hole 43 is a circular hole. The third through hole 43 is arranged circumferentially between the pair of first through holes 41 and second through holes 42 and another pair of first through holes 41 and second through holes 42 arranged circumferentially adjacent to the pair of first through holes 41 and second through holes 42. The third through hole 43 is positioned circumferentially between the second curved portion 41e of the first through hole 41 positioned on the radial inside of one magnet holding portion 23 and the second curved portion 42e of the second through hole 42 positioned on the radial inside of the magnet holding portion 23 circumferentially adjacent to the one magnet holding portion 23.

The circumferential position of the third through hole 43 includes the circumferential position at the center between the magnet holding portions 23 adjacent to each other in the circumferential direction. The circumferential position at the center between the magnet holding portions 23 adjacent to each other in the circumferential direction is the circumferential position of the inter-magnetic pole center line AXq. That is, the third through hole 43 is arranged on the inter-magnetic pole center line AXq, that is, on the q axis of the rotor 10. In the present preferred embodiment, the center CP of the circular third through hole 43 is arranged on the inter-magnetic pole center line AXg, that is, on the q axis. The radially outer end of the third through hole 43 is inscribed in the imaginary circle IC. The third through hole 43 has a part whose circumferential position is the same as that of the first through hole 41 and the second through hole 42 arranged across the inter-magnetic pole center line AXq. The third through hole 43 is positioned on the radially outside of the circumferentially outer (+θ side) end of the first through hole 41 and the circumferentially outer (−θ side) end of the second through hole 42. The circumferentially outer end of the first through hole 41 is the third straight portion 41c. The circumferentially outer end of the second through hole 42 is the third straight portion 42c.

As illustrated in FIG. 4, the rotor core 20 has a first bridge portion 51a. The first bridge portion 51a is a portion of the rotor core 20 positioned between the third through hole 43 and the second curved portion 41e arranged with the third through hole 43 interposed in the circumferential direction. The first bridge portion 51a extends in an arc shape along the circumferential direction about the center CP of the third through hole 43. The first bridge portion 51a extends in an arc shape toward the circumferential rear side (−θ side) and the radial outside from the position on the radial inside of the third through hole 43. The radially outer end of the first bridge portion 51a is positioned between the radially outer end of the first through hole 41 and the radially outer end of the third through hole 43 in the circumferential direction. The circumferential dimension of the radially outside part of the first bridge portion 51a increases toward the radial outside. When viewed in the axial direction, the opening edge of the third through hole 43 has a portion sandwiching the first bridge portion 51a with the second curved portion 41e and extending along the second curved portion 41e.

The rotor core 20 has a first bridge portion 51b. The first bridge portion 51b is a portion of the rotor core 20 positioned between the third through hole 43 and the second curved portion 42e arranged with the third through hole 43 interposed in the circumferential direction. The first bridge portion 51b extends in an arc shape along the circumferential direction about the center CP of the third through hole 43. The first bridge portion 51a and the first bridge portion 51b are arranged line-symmetrically with respect to the inter-magnetic pole center line AXq. The first bridge portion 51b extends in an arc shape toward the circumferential front side (+0 side) and the radial outside from the position on the radial inside of the third through hole 43. The radially inner end of the first bridge portion 51a and the radially inner end of the first bridge portion 51b are connected to each other. The radially outer end of the first bridge portion 51a is positioned between the radially outer end of the second through hole 42 and the radially outer end of the third through hole 43 in the circumferential direction. The circumferential dimension of the radially outside part of the first bridge portion 51b increases toward the radial outside. When viewed in the axial direction, the opening edge of the third through hole 43 has a portion sandwiching the first bridge portion 51b with the second curved portion 42e and extending along the second curved portion 42e.

As illustrated in FIG. 3, the rotor core 20 has a second bridge portion 52. The second bridge portion 52 is a portion of the rotor core 20 positioned circumferentially between the first straight portion 41a of the first through hole 41 and the first straight portion 42a of the second through hole 42. In other words, the second bridge portion 52 is a portion of the rotor core 20 positioned circumferentially between the first through hole 41 and the second through hole 42 that are provided in one magnet holding portion 23. The second bridge portion 52 extends linearly in the radial direction parallel to the magnetic pole center line AXd. The circumferential center of the second bridge portion 52 overlaps the magnetic pole center line AXd when viewed in the axial direction. The protrusion 22 is positioned radially inside the second bridge portion 52. That is, at least a part of the protrusion 22 is at the same circumferential position as that of the second bridge portion 52 of the rotor core 20 positioned circumferentially between the first through hole 41 and the second through hole 42. In the present preferred embodiment, a part of the protrusion 22 excluding both circumferential ends is at the same circumferential position as that of the second bridge portion 52.

The rotor core 20 has a third bridge portion 53. The third bridge portion 53 is a portion of the rotor core 20 positioned circumferentially between the pair of first magnet holes 31a and 31b. The third bridge portion 53 extends linearly in the radial direction parallel to the magnetic pole center line AXd. The circumferential center of the third bridge portion 53 overlaps the magnetic pole center line AXd when viewed in the axial direction.

The rotor core 20 has a fourth bridge portion 54. The fourth bridge portion 54 is a portion of the rotor core 20 positioned circumferentially between the pair of second magnet holes 32a and 32b. The fourth bridge portion 54 extends linearly in the radial direction parallel to the magnetic pole center line AXd. The circumferential center of the fourth bridge portion 54 overlaps the magnetic pole center line AXd when viewed in the axial direction.

The rotor core 20 has a fifth bridge portion 55. The fifth bridge portion 55 is a portion of the rotor core 20 positioned circumferentially between the third straight portion 41c of the first through hole 41 and the third straight portion 42c of the second through hole 42. In other words, the fifth bridge portion 55 is a portion of the rotor core 20 positioned circumferentially between the first through hole 41 provided on the radial inside of one magnet holding portion 23 and the second through hole 42 provided on the radial inside of another magnet holding portion 23. The fifth bridge portion 55 extends linearly in the radial direction parallel to the inter-magnetic pole center line AXq. The circumferential center of the fifth bridge portion 55 overlaps the inter-magnetic pole center line AXq when viewed in the axial direction. The radially inner end of the first bridge portion 51a and the radially inner end of the first bridge portion 51b are connected to a radially outer end of the fifth bridge portion 55. The third through hole 43 is positioned radially outside the fifth bridge portion 55.

The circumferential dimension of the second bridge portion 52 is larger than the circumferential dimension of the third bridge portion 53. The circumferential dimension of the second bridge portion 52 is smaller than the circumferential dimension of the protrusion 22. The circumferential dimension of the third bridge portion 53 is larger than the circumferential dimension of the fourth bridge portion 54. The circumferential dimension of the fifth bridge portion 55 is smaller than the circumferential dimension of the second bridge portion 52. The circumferential dimension of the fifth bridge portion 55 is substantially the same as the circumferential dimension of the third bridge portion 53.

The radial dimension of the second bridge portion 52 is larger than the radial dimension of the third bridge portion 53. The radial dimension of the third bridge portion 53 is larger than the radial dimension of the fourth bridge portion 54. The radial dimension of the fifth bridge portion 55 is smaller than the radial dimension of the second bridge portion 52. The radial dimension of the fifth bridge portion 55 is substantially the same as the radial dimension of the third bridge portion 53.

According to the present preferred embodiment, the rotor core 20 has the first through hole 41 and the second through hole 42 axially penetrating the rotor core 20 and circumferentially adjacent to each other. Therefore, the weight of the rotor core 20 can be reduced. When viewed in the axial direction, each of the opening edge of the first through hole 41 and the opening edge of the second through hole 42 includes the first straight portions 41a and 42a extending along the radial direction, the second straight portions 41b and 42b extending toward the circumferential one side from the radially inner end of the first straight portions 41a and 42a, the third straight portions 41c and 42c extending radially outward from the end on the circumferential one side of the second straight portions 41b and 42b, the first curved portions 41d and 42d extending toward the circumferential one side from the radially outer end of the first straight portions 41a and 42a, and the second curved portions 41e and 42e connecting the end on the circumferential one side of the first curved portions 41d and 42d and the radially outer end of the third straight portions 41c and 42c. Since the first through hole 41 and the second through hole 42 have such shapes, the first through hole 41 and the second through hole 42 can be hardly deformed as compared with a case where the first through hole 41 and the second through hole 42 have simple shapes such as a circular shape or a polygonal shape. Due to this, even if the size of the first through hole 41 and the size of the second through hole 42 are increased to some extent to further reduce the weight of the rotor core 20, the rotor core 20 is hardly deformed around the first through hole 41 and the second through hole 42. Therefore, it is possible to further reduce the weight of the rotor core 20 while securing rigidity of the rotor core 20. Therefore, even if a relatively large centrifugal force is applied to the rotor core 20 when the rotor 10 rotates at a high speed or the like, the rotor core 20 can be suppressed from deforming.

According to the present preferred embodiment, the plurality of magnet holding portions 23 are provided along the circumferential direction. The first through hole 41 and the second through hole 42 are each provided on the radial inside of the plurality of magnet holding portions 23. Therefore, it is possible to further reduce the weight of the rotor core 20 by the plurality of first through holes 41 and the plurality of second through holes 42.

According to the present preferred embodiment, the rotor core 20 has the third through hole 43 axially penetrating the rotor core 20. Therefore, it is possible to further reduce the weight of the rotor core 20 by the third through hole 43. Besides, the third through hole 43 is positioned circumferentially between the second curved portion 41e of the first through hole 41 positioned on the radial inside of one magnet holding portion 23 and the second curved portion 42e of the second through hole 42 positioned on the radial inside of the magnet holding portion 23 circumferentially adjacent to the one magnet holding portion 23. Therefore, when the second curved portions 41e and 42e are formed in an arc shape recessed inward each through hole, the third through hole 43 can be provided by using the circumferential interval between the second curved portions 41e and 42e. The third through hole 43 can be easily arranged on the q axis of the rotor 10. Therefore, the third through hole 43 can suppress the magnetic flux flowing between the rotor 10 and the stator 102 from leaking radially inward relative to the magnet holding portion 23 along the q axis. That is, the third through hole 43 can be used as a flux barrier portion. This makes it possible to suppress the magnetic efficiency of the rotating electrical machine 100 from decreasing. Therefore, it is possible to suppress the output of the rotating electrical machine 100 from decreasing.

According to the present preferred embodiment, the rotor core 20 has the first bridge portions 51a and 51b positioned between the third through hole 43 and the second curved portions 41e and 42e arranged with the third through hole 43 interposed in the circumferential direction. When viewed in the axial direction, the opening edge of the third through hole 43 has a portion sandwiching the first bridge portions 51a and 51b with the second curved portions 41e and 42e and extending along the second curved portions 41e and 42e. Therefore, even if the third through hole 43 is provided to further reduce the weight of the rotor core 20, the rigidity of the rotor core 20 can be secured by providing the first bridge portions 51a and 51b.

According to the present preferred embodiment, the circumferential dimension of the radially outside parts of the first bridge portions 51a and 51b increases toward the radial outside. Therefore, the rigidity of the first bridge portions 51a and 51b can be suitably increased in the radially outside part, where the centrifugal force tends to be large. This makes it possible to ensure the rigidity of the rotor core 20 more suitably by the first bridge portions 51a and 51b.

According to the present preferred embodiment, the circumferential position of the third through hole 43 includes the circumferential position at the center between the magnet holding portions 23 adjacent in the circumferential direction. This makes it possible to arrange the third through hole 43 on the q axis of the rotor 10. Due to this, the third through hole 43 can suitably suppress the magnetic flux flowing between the rotor 10 and the stator 102 from flowing radially inward relative to the magnet holding portion 23 along the q axis. Therefore, it is possible to suitably suppress the output of the rotating electrical machine 100 from decreasing.

According to the present preferred embodiment, in each of the first through hole 41 and the second through hole 42, the ends of the first curved portions 41d and 42d on the side connected to the second curved portions 41e and 42e are positioned closer to the other through holes of the first through hole 41 and the second through hole 42 in the circumferential direction than the ends of the second straight portions 41b and 42b on the side connected to the third straight portions 41c and 42c. The second curved portions 41e and 42e have shapes curved in an orientation recessed toward the side where the other through hole is positioned in the circumferential direction when viewed in the axial direction. Since the first through hole 41 and the second through hole 42 have such shapes, the first through hole 41 and the second through hole 42 can be less easily deformed, and the rigidity of the rotor core 20 can be more suitably secured. The third through hole 43 can be easily arranged circumferentially between the second curved portion 41e of the first through hole 41 and the second curved portion 42e of the second through hole 42.

According to the present preferred embodiment, the circumferential dimension of the second bridge portion 52 is larger than the circumferential dimension of the third bridge portion 53. Besides, the circumferential dimension of the third bridge portion 53 is larger than the circumferential dimension of the fourth bridge portion 54. Therefore, the circumferential dimension of the second bridge portion 52 can be made relatively large, and the rigidity of the second bridge portion 52 can be easily secured even if the second bridge portion 52 is made radially large. This makes it possible to suitably ensure the rigidity of the rotor core 20 while further reducing the weight of the rotor core 20 by radially enlarging the first through hole 41 and the second through hole 42. Even if the third bridge portion 53 is made radially larger than the fourth bridge portion 54, the rigidity of the third bridge portion 53 can be easily secured. Therefore, it is possible to suitably ensure the rigidity of the rotor core 20 while making the magnetic flux generated by the magnetic pole portion 12 suitable by making the first magnet holes 31a and 31b radially larger than the second magnet holes 32a and 32b. As described above, by bringing the circumferential dimension of the second bridge portion 52, the circumferential dimension of the third bridge portion 53, and the circumferential dimension of the fourth bridge portion 54 into the above-described dimensional relationship, it is possible to suitably secure the rigidity of the rotor core 20 while making each of the first through hole 41, the second through hole 42, the first magnet holes 31a and 31b, and the second magnet holes 32a and 32b suitable sizes.

According to the present preferred embodiment, the inner peripheral surface of the shaft hole 21 is provided with the protrusion 22 protruding radially inward. That is, at least a part of the protrusion 22 is at the same circumferential position as that of the part of the rotor core 20 positioned circumferentially between the first through hole 41 and the second through hole 42. Therefore, the protrusion 22 makes it possible to improve the rigidity of the rotor core 20 in a part of the rotor core 20 positioned circumferentially between the first through hole 41 and the second through hole 42, that is, the radial inside of the second bridge portion 52. This makes it possible to suppress the first through hole 41 and the second through hole 42 from deforming when the shaft 11 is press-fitted into the shaft hole 21.

According to the present preferred embodiment, an angle φ formed by the first straight portion 41a and the second straight portion 41b is an obtuse angle. This makes it possible to improve the rigidity of the corner part of the first through hole 41 as compared with the case where the angle φ formed by the first straight portion 41a and the second straight portion 41b is a right angle or an acute angle. Therefore, it is possible to ensure the rigidity of the rotor core 20 more suitably. The same applies to the second through hole 42.

According to the present preferred embodiment, the connection portion between the third straight portion 41c and the second curved portion 41e is the first arc portion 41f having an arc shape as viewed in the axial direction. The connection portion between the first curved portion 41d and the second curved portion 41e is a second arc portion 41g having an arc shape as viewed in the axial direction.

The curvature radius of the second curved portion 41e is larger than the curvature radius of the second arc portion 41g. The curvature radius of the second arc portion 41g is larger than the curvature radius of the first arc portion 41f. By bringing the curvature radius of the portion extending in the arc shape at the opening edge of the first through hole 41 into such a relationship, it is possible to suppress stress from concentrating on the opening edge of the first through hole 41. Therefore, the first through hole 41 can be less easily deformed, and the rigidity of the rotor core 20 can be more suitably secured. The same applies to the second through hole 42.

The present invention is not limited to the above-described preferred embodiment, and other configurations and methods can be adopted within the scope of the technical idea of the present invention. The opening edge of the first through hole may have any shape as long as the opening edge has the first straight portion, the second straight portion, the third straight portion, the first curved portion, and the second curved portion. The opening edge of the second through hole may have any shape as long as the opening edge has the first straight portion, the second straight portion, the third straight portion, the first curved portion, and the second curved portion. The angle formed by the first straight portion and the second straight portion may be an acute angle or a right angle. The first curved portion and the second curved portion may have a curved line in any shape. The connection portion between the portions constituting the opening edge of the first through hole does not have to have an arc shape, and may have a sharp angular shape. When the connection portion between the third straight portion and the second curved portion is the first arc portion and the connection portion between the first curved portion and the second curved portion is the second arc portion, the curvature radius of the first arc portion, the curvature radius of the second arc portion, and the curvature radius of the second curved portion may have any magnitude relationship with one another. The first through hole and the second through hole need not have circumferentially symmetrical shapes. The number of first through holes and the number of second through holes are not particularly limited as long as each of them is at least one. The shape of the third through hole may be any shape. The third through hole needs not be provided.

The shape of the first bridge portion, the shape of the second bridge portion, the shape of the third bridge portion, and the shape of the fourth bridge portion are not particularly limited. The circumferential dimension of the second bridge portion, the circumferential dimension of the third bridge portion, and the circumferential dimension of the fourth bridge portion may have any magnitude relationship with one another.

The rotating electrical machine to which the present invention is applied is not limited to a motor, and may be a generator. The application of the rotating electrical machine is not particularly limited. For example, the rotating electrical machine may be mounted on a vehicle or may be mounted on equipment other than a vehicle. The configurations described above in the present description may be appropriately combined in a range where no conflict arises.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotor core of a rotor rotatable about a central axis, the rotor core comprising:
a pair of first magnet holes circumferentially adjacent to each other;
a pair of second magnet holes positioned radially outside the pair of first magnet holes and circumferentially adjacent to each other; and
a first through hole and a second through hole axially penetrating the rotor core and circumferentially adjacent to each other, wherein
the first through hole and the second through hole are positioned radially inside the pair of first magnet holes, and
when viewed in an axial direction, each of an opening edge of the first through hole and an opening edge of the second through hole includes
a first straight portion extending along a radial direction,
a second straight portion extending toward a circumferential one side from a radially inner end of the first straight portion,
a third straight portion extending radially outward from an end on a circumferential one side of the second straight portion,
a first curved portion extending toward a circumferential one side from a radially outer end of the first straight portion, and
a second curved portion connecting an end on a circumferential one side of the first curved portion and a radially outer end of the third straight portion.

2. The rotor core according to claim 1 comprising
a plurality of the magnet holding portions, each of the magnet holding portions having the pair of first magnet holes and the pair of second magnet holes, wherein
the plurality of the magnet holding portions are provided along a circumferential direction, and
each of the first through hole and the second through hole is provided on a radially inside of the plurality of magnet holding portions.

3. The rotor core according to claim 2 comprising a third through hole axially penetrating the rotor core, wherein
the third through hole is positioned circumferentially between the second curved portion of the first through hole positioned on a radial inside of one of the magnet holding portions and the second curved portion of the second through hole positioned on a radial inside of the magnet holding portion circumferentially adjacent to the one of the magnet holding portions.

4. The rotor core according to claim 3 comprising a first bridge portion positioned between the third through hole and each of the second curved portions arranged with the third through hole interposed in a circumferential direction, wherein
when viewed in an axial direction, an opening edge of the third through hole has a portion sandwiching the first bridge portion with the second curved portion and extending along the second curved portion.

5. The rotor core according to claim 4, wherein a circumferential dimension of a radially outside part of the first bridge portion increases toward a radial outside.

6. The rotor core according to claim 3, wherein a circumferential position of the third through hole includes a circumferential position at a center between the magnet holding portions adjacent to each other in a circumferential direction.

7. The rotor core according to claim 1, wherein
in each of the first through hole and the second through hole,
an end of the first curved portion on a side connected to the second curved portion is positioned closer to another through hole of the first through hole and the second through hole in a circumferential direction than an end of the second straight portion on a side connected to the third straight portion, and
the second curved portion has a shape curved in an orientation recessed toward a side where the other through hole is positioned in a circumferential direction when viewed in an axial direction.

8. The rotor core according to claim 1 comprising:
a second bridge portion positioned circumferentially between the first straight portion of the first through hole and the first straight portion of the second through hole;
a third bridge portion positioned circumferentially between the pair of first magnet holes; and
a fourth bridge portion positioned circumferentially between the pair of second magnet holes, wherein
a circumferential dimension of the second bridge portion is larger than a circumferential dimension of the third bridge portion, and
a circumferential dimension of the third bridge portion is larger than a circumferential dimension of the fourth bridge portion.

9. The rotor core according to claim 1 comprising a shaft hole axially penetrating the rotor core, wherein
an inner peripheral surface of the shaft hole is provided with a protrusion protruding radially inward, and
at least a part of the protrusion is at a same circumferential position as a circumferential position of a part of the rotor core, the part being positioned circumferentially between the first through hole and the second through hole.

10. The rotor core according to claim 1, wherein an angle formed by the first straight portion and the second straight portion is an obtuse angle.

11. The rotor core according to claim 1, wherein
a connection portion between the third straight portion and the second curved portion is a first arc portion having an arc shape as viewed in an axial direction,
a connection portion between the first curved portion and the second curved portion is a second arc portion having an arc shape as viewed in an axial direction,
a curvature radius of the second curved portion is larger than a curvature radius of the second arc portion, and
the curvature radius of the second arc portion is larger than a curvature radius of the first arc portion.

12. A rotating electrical machine comprising:
a rotor having the rotor core according to claim 1 and a plurality of magnets arranged in the pair of first magnet holes and the pair of second magnet holes; and
a stator opposing the rotor across a gap.
